(19) United States
(12) Patent Application Publication
(10) Pub. No.: US 2011/0227933 A1
(43) Pub. Date: Sep. 22, 2011

(54) METHOD AND APPARATUS FOR TRANSMITTING A GRAPHICAL IMAGE INDEPENDENTLY FROM A CONTENT CONTROL PACKAGE

(76) Inventor: Imed Bouazizi, Tampere (FI)

(21) Appl. No.: 13/013,236

(22) Filed: Jan. 25, 2011

Related U.S. Application Data
(60) Provisional application No. 61/297,994, filed on Jan. 25, 2010.

(51) Int. Cl. G06T 1/00

(52) U.S. Cl. 345/501

(57) ABSTRACT

An apparatus may include a graphical image fragmentor configured to form a graphical content package corresponding to a graphical image. The apparatus may also include a content control package former configured to form a content control package including a graphical content package identifier configured to display the graphical image. The graphical image may be transmitted independently from the content control package. A graphical image fragmentor may be configured to fragment the graphical image into a plurality of graphical image formats. The apparatus may also include a graphical content timer module configured to start a graphical content timer. Further, the apparatus may include a content control timer module configured to start a content control timer. Related methods and computer program products are also provided.

### CROSS REFERENCE TO RELATED APPLICATIONS

This application claims priority from U.S. Provisional Application No. 61/297,994 filed Jan. 25, 2010, which is hereby incorporated herein in their entirety by reference.

### TECHNOLOGICAL FIELD

Embodiments of the present invention relate generally to transmission of graphical images and, more particularly, relate to an apparatus, method and a computer program product for causing transmission a graphical image independently from a content control package.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of content transfer. Over the past years several multimedia solutions, both standardized and proprietary, have become available. For example, ADOBE FLASH® and MICROSOFT SILVERLIGHT™ are two widely used multimedia systems with user interactivity functionality, referred to as “rich media systems”. Further, the 3rd Generation Partnership Project (3GPP) has defined an open rich media system, Dynamic Interactive Multimedia Scenes (DIMS), for describing two-dimensional vector graphics.

DIMS is configured for delivery of rich media services over mobile networks. In particular, DIMS uses the Scalable Vector Graphics (SVG) family of specifications of an Extensible Markup Language (XML) based file format. SVG is extended through definition of SVG modules that provide specific functionality. Besides the scalable graphics functionality, SVG provides multimedia functionality to enable synchronization, graphical animations, and the embedding of audio and video elements. Scripting in SVG is enabled through providing interfaces to the micro Document Object Model (uDOM). SVG is specified and maintained by the World Wide Web Consortium (W3C).

Thus, DIMS defines and controls multimedia sessions using SVG. Consequently, SVG is used as the entry point to the multimedia session, which may then invoke other media such as audio and video. The audio, video, and graphical image portions of the multimedia content may be streamed continuously to the device playing the content during the session. With respect to graphical images, they may require the delivery of related data such as time and layout information to the device playing the content. In a broadcast delivery scenario, receivers may join at any point of time and may thereby need to get access to the graphics images promptly. As a consequence, the graphics images may need to be retransmitted continuously, which raises the bandwidth consumption. In addition, handling the timelines for display of the graphical images may require the continuous transmission of content control information (e.g. to extend the duration of display of a certain graphical image). This may be the case, for example, if the display duration of a specific graphical image is not known ahead of time. However, this configuration for multimedia transfer may not in all situations be optimal due to the associated bandwidth requirements.

Accordingly it may be desirable to provide improved methods, apparatuses, and computer program products for causing transmission of graphical images.

### BRIEF SUMMARY

A method, apparatus and computer program product are therefore provided to enable the transmission of graphical images with associated data such as time and layout specifications. As such, for example, a graphical image may be transmitted independently from a content control package comprising related specifications. Accordingly, transmission of graphical image content may be improved.

In one embodiment an apparatus comprising at least one processor and at least one memory including computer program code, the at least one memory and the computer program code configured to, with the processor, cause the apparatus to form a graphical content package corresponding to a graphical image and form a content control package comprising a graphical content package identifier configured to display the graphical image. The graphical image may be transmitted independently from the content control package.

Further, the apparatus may fragment the graphical image into a plurality of graphical image fragments. Also, the apparatus may assign the graphical content package a graphical content package identifier. The apparatus may also start a content control timer and start a graphical content timer. Additionally, the apparatus may at least cause retransmission of the graphical content package and the content control package in instances in which the content control package has changed or the content control timer has expired and additionally the graphical content package identifier has changed or the graphical content timer has expired. The apparatus may further at least cause retransmission the content control package and reset the content control timer in instances in which the content control package has changed or the content control timer has expired but the graphical content package identifier has not changed and the graphical content timer has not expired. Also, the apparatus may at least cause retransmission the graphical content package and reset the graphical content timer in instances in which the graphical content timer has expired but the content control package has not changed and the content control timer has not expired.

In a further embodiment a method comprises forming a graphical content package corresponding to a graphical image and forming a content control package comprising a graphical content package identifier configured to display the graphical image. The graphical image may be transmitted independently from the content control package.

The method may additionally include fragmenting the graphical image into a plurality of graphical image fragments. Also, the method may comprise assigning the graphical content package a graphical content package identifier. Further, the method may include starting a content control timer and starting a graphical content timer. Additionally, the method may include at least causing retransmission of the graphical content package and the content control package in instances in which the content control package has changed or the content control timer has expired and additionally the graphical content package identifier has changed or the graphical content timer has expired. The method may also include at least causing retransmission of the content control package and resetting the content control timer in instances in which the content control package has changed or the content control timer has expired but the graphical content package identifier has not changed and the graphical content timer has not expired. The method may further comprise at least causing retransmission of the graphical content package and resetting the graphical content timer in instances in which the graphical content timer has expired but the content control package has not changed and the content control timer has not expired.

In an additional embodiment a computer program product comprises at least one computer-readable storage medium having computer-executable program code portions stored therein. The computer-executable program code portions may comprise program code instructions for forming a graphical content package corresponding to a graphical image and program code instructions for forming a content control package comprising a graphical content package identifier configured to display the graphical image. The graphical image may be transmitted independently from the content control package.

The computer program product may further comprise program code instructions for fragmenting the graphical image into a plurality of graphical image fragments. Also, the computer program product may include program code instructions for starting a content control timer and starting a graphical content timer. The computer program product may additionally comprise program code instructions for at least causing retransmission of the graphical content package and the content control package in instances in which the content control package has changed or the content control timer has expired and additionally the graphical content package identifier has changed or the graphical content timer has expired. Further, the computer program product may comprise program code instructions for at least causing retransmission of the content control package and resetting the content control timer in instances in which the content control package has changed or the content control timer has expired but the graphical content package identifier has not changed and the graphical content timer has not expired. Also, the computer program product may include program code instructions for at least causing retransmission of the graphical content package and resetting the graphical content timer in instances in which the graphical content timer has expired but the content control package has not changed and the content control timer has not expired.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a schematic block diagram of a system according to an exemplary embodiment of the present invention;

FIG. 2 illustrates a schematic block diagram of an apparatus for causing transmission of a graphical content package and a content control package according to an exemplary embodiment of the present invention;

FIG. 3 illustrates a graphical content package according to an exemplary embodiment of the present invention;

FIG. 4 illustrates an alternate embodiment of a graphical content package according to an exemplary embodiment of the present invention;

FIG. 5 illustrates a content control package according to an exemplary embodiment of the present invention;

FIG. 6 illustrates two alternate ways of specifying the position of a graphical image on a display according to an exemplary embodiment of the present invention; and

FIG. 7 illustrates a flowchart according to an exemplary method for forming a graphical content package and a content control package according to an exemplary embodiment of the present invention.

### DETAILED DESCRIPTION OF THE INVENTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

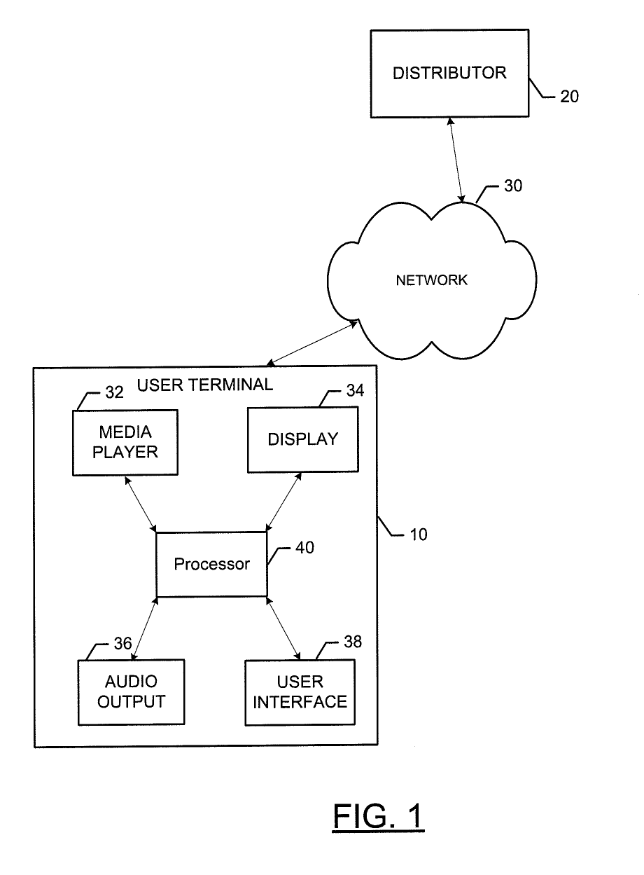

As indicated above, embodiments of the present invention may be employed in methods, apparatuses and computer program products in order to provide for improved transmission of graphical images. In this regard, for example, FIG. 1 illustrates a block diagram of a system that may benefit from embodiments of the present invention. It should be understood, however, that the system as illustrated and hereinafter described is merely illustrative of one system that may benefit from embodiments of the present invention and, therefore, should not be taken to limit the scope of embodiments of the present invention. Moreover, although Dynamic Interactive Multimedia Scenes (DIMS) was described above as one system for transferring multimedia content, the present system is not intended to be limited to embodiments of multimedia systems which are equivalent to DIMS, nor is the present system intended to be limited to use with mobile devices.

As shown in FIG. 1, an embodiment of a system in accordance with an example embodiment of the present invention may include a distributor 20. The distributor 20 may distribute content to a user terminal 10, or other end user devices. Content, as used herein, refers to audio, video, graphical images, and related media and information. Related information may include content control information such as position and time specifications which control the display characteristics of graphical images. Content thus refers to all types of media and related information and is not limited to use on any particular embodiment of an electronic device. Further, the content may in some embodiments provide for user interactivity capability, and thus the content may comprise rich media. In some embodiments the distributor 20 may distribute content which includes multiple types of media (e.g. audio, video, and graphical images).

The distributor 20 may for example be a server, server bank or other computer or other computing device or node configured to distribute content. The distributor 20 may have any number of functions or associations with various services. As such, for example, the distributor 20 may be a platform such as a dedicated server (or server bank), or the distributor may be a backend server associated with one or more other functions or services. Thus, the distributor 20 represents a potential host for a plurality of different content. The distributor 20 may distribute the content via a network 30, or the distributor may distribute the content directly to end user devices such as the user terminal 10. The distributor 20 may distribute commercial and/or non-commercial content. Accordingly, the operations performed by the distributor 20 may or may not comprise processing payment in exchange for distributing the content. In some embodiments payment may be processed by a separate device. Further, in some embodiments the distributor 20 may distribute content which is encrypted or otherwise protected.

The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), e.g., the Internet. In turn, other devices such as processing elements (e.g., personal computers, server computers or the like) may be included in or coupled to the network 30. By directly or indirectly connecting the user terminal 10 and the other devices to the network 30, the user terminal 10 and/or the other devices may be enabled to communicate with each other, for example, according to numerous communication protocols including Hypertext Transfer Protocol (HTTP) and/or the like, to thereby carry out various communication or other functions of the user terminal 10 and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity. Further, although the various systems and devices shown in FIG. 1 are illustrated as being in communication through the network 30, it should be understood that in some embodiments some communication may occur directly as opposed to through the network.

The user terminal 10 may comprise a processor 40. The processor 40 may be embodied in a number of different ways. For example, the processor 40 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an exemplary embodiment, the processor 40 may be configured to execute instructions stored in a memory device or otherwise accessible to the processor. Alternatively or additionally, the processor 40 may be configured to execute hard coded functionality. As such, whether configured by hardware or software methods, or by a combination thereof, the processor 40 may represent an entity (e.g., physically embodied in circuitry) capable of performing operations according to embodiments of the present invention while configured accordingly. Thus, for example, when the processor 40 is embodied as an ASIC, FPGA or the like, the processor may be specifically configured hardware for conducting the operations described herein. Alternatively, as another example, when the processor 40 is embodied as an executor of software instructions, the instructions may specifically configure the processor 40 to perform the algorithms and/or operations described herein when the instructions are executed. However, in some cases, the processor 40 may be a processor of a specific device (e.g., a mobile terminal or network device) adapted for employing embodiments of the present invention by further configuration of the processor by instructions for performing the algorithms and/or operations described herein. The processor 40 may include, among other things, a clock, an arithmetic logic unit (ALU) and logic gates configured to support operation of the processor.

In an exemplary embodiment, the processor 40 may be embodied as, include or otherwise control a media player 32. The media player 32 may be configured to play the content transmitted by the distributor 20. The media player 32 may comprise software and/or circuitry capable of reading and playing the content. In this regard, the content may be played such as by displaying graphical images and/or video comprising the content on a display 34, and/or outputting audio through an audio output 36. The display 34, which may be controlled by the processor 40, may comprise a screen on which the graphical images and/or video are displayed, or the display may additionally or alternatively comprise an external output device or connection for transmission of the graphical images and/or video to an external device such as an external monitor. Similarly, the audio output 36, which may be controlled by the processor 40, may comprise an internal speaker or external output device or connection which may be used, for example, to connect a pair of headphones or transmit any audio portion of the content to an external device. The user terminal 10 may further comprise a user interface 38 which may allow a user to control play of the content through the media player 32. The user interface 38, which may be controlled by the processor 40, may in some embodiments further allow the user to interact with the content when it comprises rich media user interactive content such as links to external content.

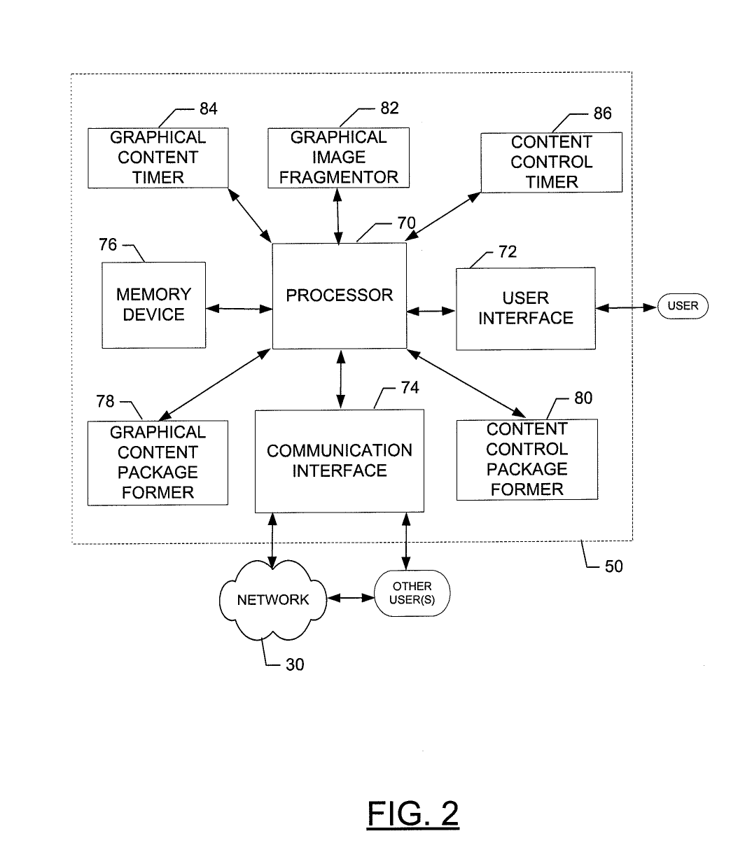

In an exemplary embodiment, an apparatus 50 is provided that may be employed at devices performing exemplary embodiments of the present invention. The apparatus 50 may be embodied, for example, as any device hosting, including, controlling or otherwise comprising the distributor 20. Thus, the apparatus 50 could be a server or other device of the distributor 20 or of the network 30 itself when the content protecting and packaging system is embodied at or included with a respective one of these entities. However, embodiments may also be embodied on a plurality of other devices such as for example where instances of the apparatus 50 may be embodied on both client side and server side devices. As such, the apparatus 50 of FIG. 2 is merely an example and may include more, or in some cases less, than the components shown in FIG. 2.

Referring now to FIG. 2, an apparatus 50 for forming a graphical content package and a content control package is provided. The apparatus 50 may include or otherwise be in communication with a processor 70, a user interface 72, a communication interface 74 and a memory device 76. The memory device 76 may include, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases or storage locations that store information and/or media content.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or the like. In an exemplary embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing embodiments of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as Bluetooth, Infrared, UWB, WiFi, and/or the like, which are being increasingly employed in connection with providing home connectivity solutions.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen, a microphone, a speaker, or other input/output mechanisms. In an exemplary embodiment in which the apparatus is embodied as a server or some other network devices, the user interface 72 may be limited, remotely located, or eliminated.

In an exemplary embodiment, the processor 70 may be embodied as, include or otherwise control a graphical content package former 78. The graphical content package former 78, according to some embodiments, is any means such as a device or circuitry embodied in hardware, software or a combination of hardware and software that is configured to form and/or cause transmission of a graphical content package, such as through the communication interface 74 to the network 30. In other embodiments the graphical content package former 78 may transmit the graphical content package directly to a user terminal, such as the user terminal 10 of FIG. 1. When the graphical content package former 78 causes transmission of a graphical content package, it may transmit the graphical content package itself, or the actual transmission may be conducted by another apparatus or element.

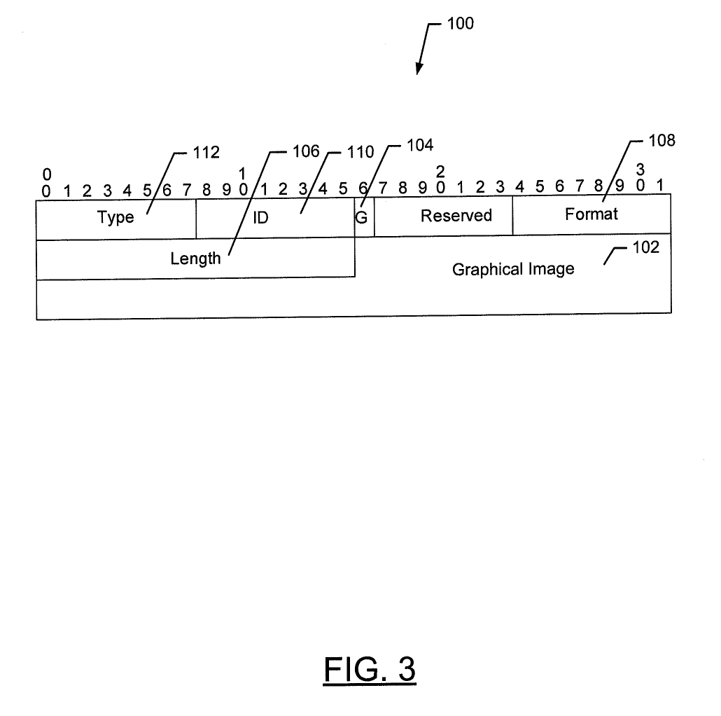

FIG. 3 illustrates an embodiment of a graphical content package 100 according to an exemplary embodiment of the invention, which may in some embodiments be formed and/or transmitted by the graphical content package former 78. The graphical content package 100 may comprise a graphical image 102. However, the graphical content package 100 may further comprise additional or alternate content. For example, in alternate embodiments, instead of including the graphical image 102, the graphical content package 100 may instead comprise a link to a graphical image which is accessible, for example, via the network 30. Accordingly, the graphical content package 100 may further comprise a content flag 104, which indicates whether the graphical image 102 is embedded, or linked or otherwise referenced such as via a Uniform Resource Locator (URL).

Regardless of whether the graphical image 102 is linked or embedded, the graphical content package 100 may further comprise a content length indicator 106, which indicates the size of the graphical image or link. Additionally, the graphical content package 100 may comprise a content format indicator 108, which indicates the format of the graphical image 102. Thus, for example, the graphical image 102 may be formed and transmitted in multiple formats in order to ensure compatibility with various different types of user terminals 10 having different media players 32. In some embodiments multiple formats of graphical images 102 may be formed and transmitted within a single graphical content package 100, in which case the graphical content package may include multiple content format indicators 108 corresponding to each format of the graphical image. In other embodiments the various formats of the graphical image 102 may be formed and transmitted in separate graphical content packages 100, in which case each graphical content package may comprise a single content format indicator 108. Additionally, the graphical content package 100 may comprise a type indicator 112, which is used to indicate that the package is a graphical content package. The graphical content package 100 may further include a graphical content package identifier 110 which may be assigned by the apparatus 50 to uniquely identify the graphical content package or the graphical image 102 in particular. As will be discussed later, the graphical content package identifier 110 may be used to select the graphical content package 100 for display of the graphical image 102. Further, by using the graphical content package identifier 110, multiplexing of different graphical content packages 100 may occur. For example, the multiplexing may occur via multiple separate distributors 20. However embodiments of the present invention may use a unicast system, or other types of broadcasting.

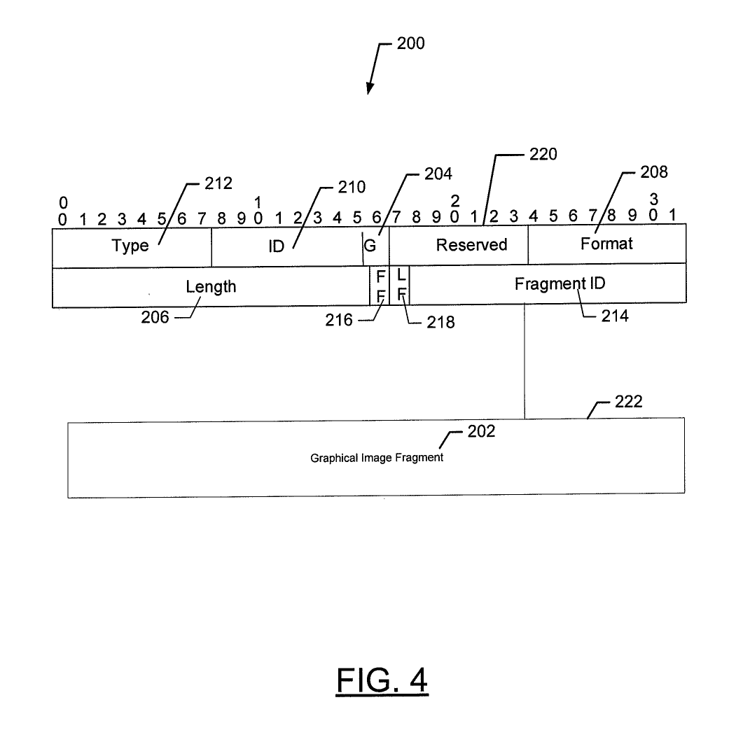

FIG. 4 illustrates an alternate embodiment of a graphical content package 200. When using Real-time Transport Protocol (RTP), a standardized packet format for delivering audio and video over the internet, the graphical content information portion 220 of the graphical content package 200 may be used as the payload format header, and the graphical image may be carried in the payload portion 222 of the graphical content package. Returning to FIG. 2, the apparatus 50 may include a graphical image fragmentor 82 which fragments the graphical image 102 into a plurality of graphical image fragments. Accordingly, the fragmentation functionality provided by the graphical image fragmentor 82 of the apparatus 50 may allow for the transmission of large graphical images over RTP. As illustrated in FIG. 4, each graphical image fragment 202 may be identified by a fragment identifier 214 and two position flags 216, 218 identifying whether the graphical image fragment is the first fragment, the last fragment, or both. As with the graphical content package 100 illustrated in FIG. 3, the graphical content package 200 of FIG. 4 may further include a content flag 204, a content length indicator 206, a format indicator 208, a graphical content package identifier 210, and a type indicator 212.

Once again returning to the apparatus 50 of FIG. 2, the processor 70 may be embodied as, include or otherwise control a content control package former 80. The content control package former 80, according to some embodiments, is any means such as a device or circuitry embodied in hardware, software or a combination of hardware and software that is configured to form and/or cause transmission of a content control package, such as through the communication interface 74 to the network 30. In other embodiments the content control package former 80 may transmit the content control package directly to a user terminal, such as the user terminal 10 of FIG. 1. When the content control package former 80 causes transmission of a content control package, it may transmit the content control package itself, or the actual transmission may be conducted by another apparatus or element.

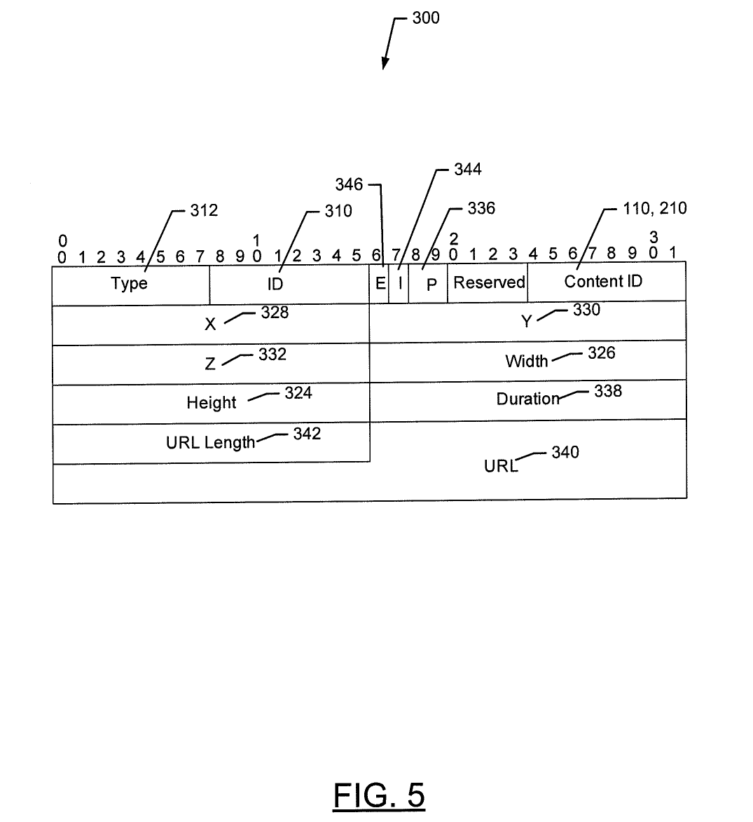

FIG. 5 illustrates an embodiment of a content control package 300, which may in some embodiments be formed or transmitted by the content control package former 80. When using RTP, the content control package 300 illustrated in FIG. 5 may comprise an RTP payload format. In general, the content control package 300 may comprise data, information and other specifications which control the display of the graphical images 102, such as on the display 34 of the user terminal 10. Accordingly, the content control package 300 may comprise a type indicator 312 which is used to indicate that the package is a content control package. This information may be used, for example, by the media player 32 of the user terminal 10 to allow the media player to use the information contained within the content control package 300 to control the display of a graphical content package 100, 200 which is also received by the user terminal. In some embodiments, however, the graphical content package and the content control package may be embodied in an integral package with a different type indicator. The content control package 300 may include a content control package identifier 310 which uniquely identifies the content control package. Thus, for example, when multiple graphical images 102 are to be displayed simultaneously, the media player 32 may be able to recognize that for each graphical image there is a corresponding content control package 300 with instructions for display of that graphical image. In this regard, the content control package 300 may further include a graphical content package identifier 110, 210 which specifies the graphical content package 100, 200 and corresponding graphical image 102 which is to be displayed.

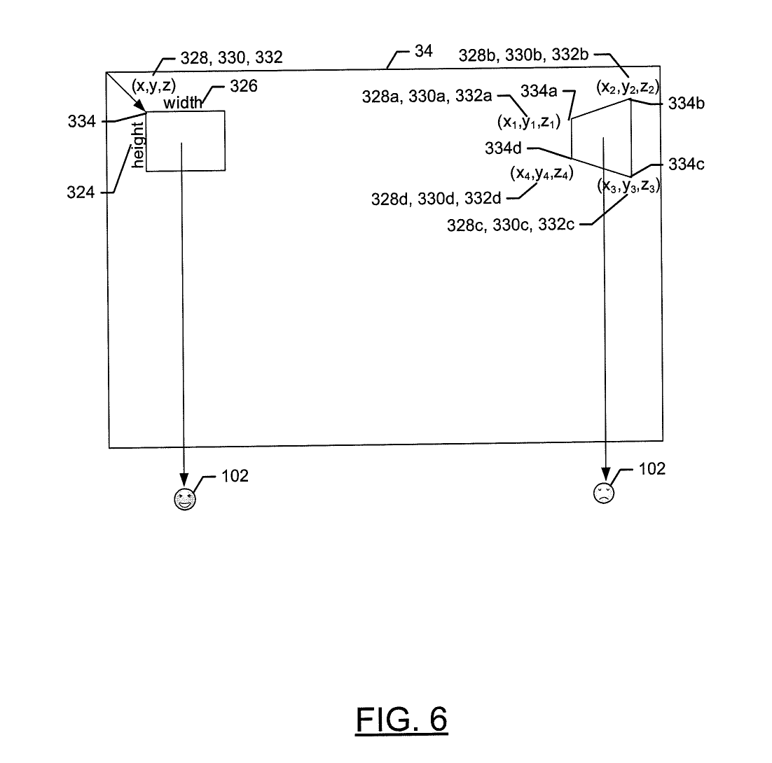

Beyond merely specifying the graphical image 102 which is to be displayed, the content control package 300 may further specify additional display characteristics of the graphical image. For example, the height 324 and width 326 of the graphical image 102 may be specified in conjunction with the X 328, Y 330, and Z 332 coordinates of the graphical image. Accordingly, the display of the graphical image 102 on the display 34 of the user terminal 10, such as within a video element or more generally a client area created by the media player 32 may be determined. Thus, as illustrated in FIG. 6, the graphical image 102 may be positioned on the display 34 by the X 328, Y 330, and Z 332 coordinates and the height 324 and width 326 of the graphical image are also specified. In particular, the X 328, Y 330, and Z 332 coordinates may define the position of a reference corner 334 from which the height 324 and width 326 of the graphical image 102 extend. In an alternate embodiment, as further illustrated in FIG. 6, each corner 334a-d of the graphical image 102 may be specified instead of specifying a reference corner 334 with height 324 and width 326 data. Specifying the X 328a-d, Y 330a-d, and Z 332a-d coordinates of each corner 334a-d of the graphical image 102 may be preferable in embodiments in which the graphical image is displayed in a 3-D format.

Returning to FIG. 5, the content control package 300 may further include position indicator 336 which indicates whether the position of the graphical image 102 is defined in terms of a reference corner 334 with height 324 and width 326 data, or X 328a-d, Y 330a-d, and Z 332a-d coordinates of each corner 334a-d of the graphical image. Additionally, the content control package 300 may include a duration indicator 338 which specifies the duration for which the graphical image 102 should be displayed. Also, the content control package 300 may include an interactive content element 340, which may, for example, be accessed through the user interface 38 of the user terminal 10 such as by clicking on the graphical image 102 or making a touch gesture on the graphical image. The interactive content element 340 may comprise a link such as a URL that points to additional content such as a website. Accordingly, the content control package 300 may also include an interactive content length indicator 342 which defines the length of the interactive content, such as the link. Additionally, an interactivity indicator 344 may be used to indicate whether the content control package 300 includes the interactive content element 340. The content control package 300 may also comprise an empty indicator 346, which may be used to indicate to the media player 32 when a graphical image 102 is not currently being displayed. In such instances, the media player 32 may thereby ignore the graphical content package identifier 110, 210, duration indicator 338, and interactive content element 340, as they may not be needed at that point in time.

By transmitting the graphical image 102 independently from the content control package 300, bandwidth associated with transmitting and displaying the graphical image 102 may be reduced. In this regard, the graphical image 102 which is displayed and/or the characteristics of the graphic image may change over time. Accordingly, as described above, some prior art systems continuously retransmit the graphical image and associated characteristics in order to update the graphical image on the user terminal. However, using embodiments of the present invention, the graphical content package 100, 200 which may comprise the graphical image 102 or a link thereto may be transmitted separately from the content control package 300. By transmitting the content control package 300 separately from the graphical image 102, the graphical content package 100, 200 may not need to be retransmitted each time the content control package is retransmitted, and vice versa. For example, the content control package 300 may continue to specify display of the same graphical content package 100, 200 for an extended period of time. In such circumstances, embodiments of the present invention may avoid continuously transmitting the graphical image 102, which may reduce the bandwidth required to transmit and play the graphical image. Thus, in some embodiments the graphical image 102 may be transmitted less frequently than the content control package 300 which controls the display thereof. This may be particularly beneficial in that the content control package 300 may be relatively smaller in terms of data size than that of the graphical image 102.

Although the content control package 300 and the graphical image 102 are described above as being transmitted independently, sometimes the graphical image and the content control package may be transmitted at the same time. For example, this may occur when the content control package 300 changes to specify a new graphical content package identifier 110, 210 which corresponds to a different graphical image 102. In such circumstances, the content control package 300 and the graphical image 102 may be retransmitted at the same time. However, the content control package 300 and the graphical image 102 may still be transmitted separately, and the transmissions do not necessarily have to occur at the same time. Accordingly, even in this situation the graphical image 102 may still be considered to be transmitted independently from the content control package 300. Further, although the graphical content package former 78 and content control package former 80 were described above as each comprising a portion of the apparatus 50, in alternate embodiments the graphical content package former and the content control package former may be embodied in separate apparatuses, as may be enabled by the independent transmission capabilities described above. In such instances, the system may comprise more than one distributor 20.

Once again returning to FIG. 2, in some embodiments, the processor 70 may be embodied as, include or otherwise control a graphical content timer 84 and/or a content control timer 86. The graphical content timer 84 and/or a content control timer 86, according to some embodiments, may be any means such as a device or circuitry embodied in hardware, software or a combination of hardware and software that are configured to record the passage of time, such as after the transmission of a graphical content package 100, 200 and transmission of a content control package 300, respectively. As will be discussed below, the expiration of one of the timers 84, 86 through the passage of a predetermined period of time may in some embodiments result in retransmission of the graphical content package 100, 200 and/or the content control package 300.

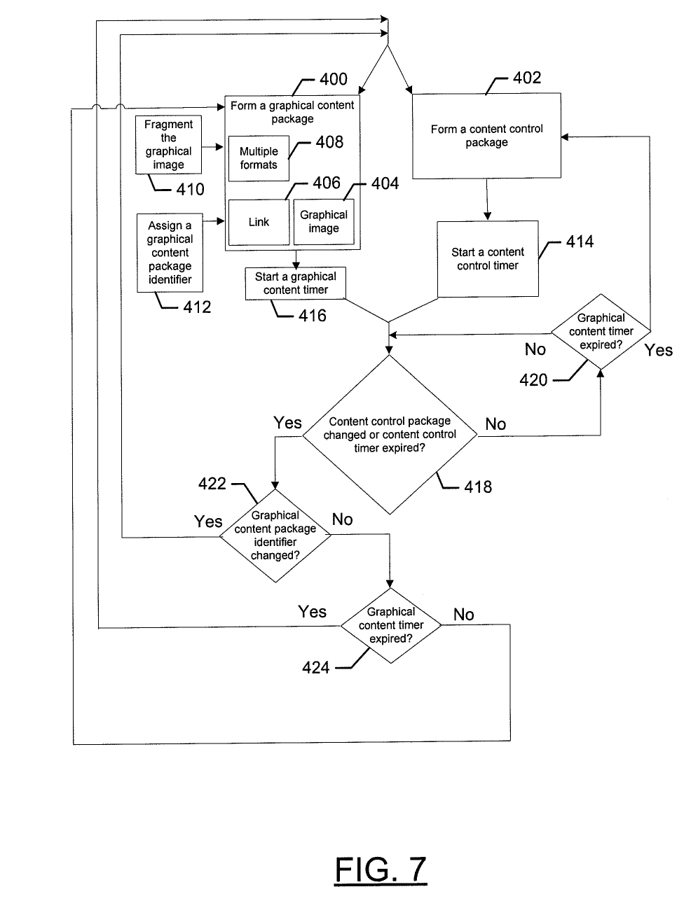

In terms of methods associated with embodiments of the present invention, the above described apparatus or other embodiments of apparatuses may be employed. In this regard, FIG. 7 is a flowchart of a system, method and program product according to exemplary embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (e.g., hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and program instruction means for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, one embodiment of a method as provided in FIG. 7 may comprise forming a graphical content package corresponding to a graphical image at operation 400 and forming a content control package comprising a graphical indicator at operation 402. Forming of packages, as described above, may include causing transmission of the package, such as through transmitting by the apparatus conducting the method, or by an external apparatus. The graphical image may be transmitted independently from the content control package. As described above, this may in some circumstances allow for reduced bandwidth consumption by transmitting the graphical image less frequently than the content control package. The graphical content package may comprise the graphical image, as indicated at block 404, or the graphical content package may comprise a link to the graphical image as indicated at block 406. Additionally or alternatively, in some embodiments the graphical content package may correspond to more than one format of the graphical image, as indicated at block 408, which may be used to ensure compatibility with a variety of user terminals 10 with media players 32.

The method may further involve fragmenting the graphical image into a plurality of graphical image fragments at operation 410, such as when using the graphical content package 200 of FIG. 4. The method may additionally comprise assigning the graphical content package a graphical content package identifier at operation 412. As discussed above, the graphical content package identifier 110, 210 may be used by the content control package 300 to select a particular graphical image 102 for display.

The method may further comprise starting a content control timer at operation 414 and starting a graphical content timer at operation 416. Thereafter, the method may further comprise determining whether the content control package has changed or the content control timer has expired at operation 418. If the determination at operation 418 is NO, then the method may further include determining whether the graphical content timer has expired at operation 420. If the determination at operation 420 is NO, the method may revert to repeating operation 418. However, if the determination at operation 420 is YES, the method may return to operation 402 to at least cause retransmission of the content control package and may additionally reset the content control timer at operation 414.

Returning to operation 418, if the determination is YES, the method may further comprise determining whether the graphical content package identifier has changed at operation 422. If the determination at operation 422 is NO, the method may further include determining whether the graphical content timer has expired at operation 424. If the determination at operation 424 is NO, the method may return to operation 400 to at least cause retransmission of the graphical content package and reset the graphical content timer at operation 416. However, if the determination at either of operation 422 or operation 424 is YES, the method may return to repeat both operations 400 and 402 and thereby at least cause retransmission of both the graphical content package and the content control package and may further reset the graphical content timer at operation 416 and reset the content control timer at operation 414.

Accordingly, the method illustrated in FIG. 7 may retransmit either one or both of the graphical content package and the content control package under certain circumstances in which retransmission may be needed in order to update the graphical image and related specifications for display of the graphical image. Circumstances in which retransmission of the graphical content package and/or the content control package may occur according to embodiments of the method illustrated in FIG. 7 may be summarized as follows: The graphical content package and the content control package may be retransmitted in instances in which the content control package has changed or the content control timer has expired and additionally the graphical content package identifier has changed or the graphical content timer has expired. Further, the content control package may be retransmitted and the content control timer may be reset in instances in which the content control package has changed or the content control timer has expired but the graphical content package identifier has not changed and the graphical content timer has not expired. Additionally, the graphical content package may be retransmitted and the graphical content timer reset in instances in which the graphical content timer has expired but the content control package has not changed and the content control timer has not expired.

In an exemplary embodiment, an apparatus for performing the method of FIG. 7 above may comprise a processor (e.g., the processor 70) configured to perform some or each of the operations (400-424) described above. The processor may, for example, be configured to perform the operations (400-424) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 400-424 may comprise, for example, the processor 70, the graphical content package former 78, the content control package former 80, the graphical image fragmentor 82, the graphical content timer 84, and the content control timer 86, and/or an algorithm executed by the processor 70 for processing information as described above. As such, in some embodiments, the apparatus for performing the method of FIG. 7 may include at least one processor and at least one memory storing computer program code. The at least one memory and the computer program code may be configured to, with the processor, perform the operations (400-424).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to:
form a graphical content package corresponding to a graphical image; and
form a content control package comprising a graphical content package identifier configured to display the graphical image,
wherein the graphical image is transmitted independently from the content control package.

2. The apparatus of claim 1, wherein the program code further causes the apparatus to fragment the graphical image into a plurality of graphical image fragments.

3. The apparatus of claim 1, wherein the program code further causes the apparatus to assign the graphical content package a graphical content package identifier.

4. The apparatus of claim 1, wherein the program code further causes the apparatus to start a content control timer and start a graphical content timer.

5. The apparatus of claim 4, wherein the program code further causes the apparatus to at least cause retransmission of the graphical content package and the content control package in instances in which the content control package has changed or the content control timer has expired and additionally the graphical content package identifier has changed or the graphical content timer has expired.

6. The apparatus of claim 4, wherein the program code further causes the apparatus to at least cause retransmission the content control package and reset the content control timer in instances in which the content control package has changed or the content control timer has expired but the graphical content package identifier has not changed and the graphical content timer has not expired.

7. The apparatus of claim 4, wherein the program code further causes the apparatus to at least cause retransmission the graphical content package and reset the graphical content timer in instances in which the graphical content timer has expired but the content control package has not changed and the content control timer has not expired.

8. A method comprising:
forming a graphical content package corresponding to a graphical image; and
forming a content control package comprising a graphical content package identifier configured to display the graphical image,
wherein the graphical image is transmitted independently from the content control package.

9. The method of claim 8, further comprising fragmenting the graphical image into a plurality of graphical image fragments.

10. The method of claim 8, further comprising assigning the graphical content package a graphical content package identifier.

11. The method of claim 8, further comprising starting a content control timer and starting a graphical content timer.

12. The method of claim 11, further comprising at least causing retransmission of the graphical content package and the content control package in instances in which the content control package has changed or the content control timer has expired and additionally the graphical content package identifier has changed or the graphical content timer has expired.

13. The method of claim 11, further comprising at least causing retransmission of the content control package and resetting the content control timer in instances in which the content control package has changed or the content control timer has expired but the graphical content package identifier has not changed and the graphical content timer has not expired.

14. The method of claim 11, further comprising at least causing retransmission of the graphical content package and resetting the graphical content timer in instances in which the graphical content timer has expired but the content control package has not changed and the content control timer has not expired.

15. A computer program product comprising at least one computer-readable storage medium having computer-executable program code portions stored therein, the computer-executable program code portions comprising:
program code instructions for forming a graphical content package corresponding to a graphical image; and
program code instructions for forming a content control package comprising a graphical content package identifier configured to display the graphical image,
wherein the graphical image is transmitted independently from the content control package.

16. The computer program product of claim 15, further comprising program code instructions for fragmenting the graphical image into a plurality of graphical image fragments.

17. The computer program product of claim 15, further comprising program code instructions for starting a content control timer and starting a graphical content timer.

18. The computer program product of claim 17, further comprising program code instructions for at least causing retransmission of the graphical content package and the content control package in instances in which the content control package has changed or the content control timer has expired and additionally the graphical content package identifier has changed or the graphical content timer has expired.

19. The computer program product of claim 17, further comprising program code instructions for at least causing retransmission of the content control package and resetting the content control timer in instances in which the content control package has changed or the content control timer has expired but the graphical content package identifier has not changed and the graphical content timer has not expired.

20. The computer program product of claim 17, further comprising program code instructions for at least causing retransmission of the graphical content package and resetting the graphical content timer in instances in which the graphical content timer has expired but the content control package has not changed and the content control timer has not expired.
